(19) United States
(12) Patent Application Publication
(10) Pub. No.: US 2017/0289836 A1
(43) Pub. Date: Oct. 5, 2017

(54) METHOD AND USER EQUIPMENT FOR UPLINK TRAFFIC MAPPING

(71) Applicant: Telefonaktiebolaget LM Ericsson (publ), Stockholm (SE)

(72) Inventor: Lars Lövsén, Göteborg (SE)

(21) Appl. No.: 15/503,672

(22) PCT Filed: Sep. 14, 2015
(86) PCT No.: PCT/EP2015/070961

§ 371 Date: Feb. 13, 2017

Related U.S. Application Data
(60) Provisional application No. 62/054,609, filed on Sep. 24, 2014.

(51) Int. Cl. H04W 28/02; H04L 12/823; H04L 12/851; H04L 12/927

(52) U.S. Cl. CPC H04W 28/0263; H04W 28/0215; H04L 47/805; H04L 47/32; H04L 47/2441

(57) ABSTRACT

The embodiments herein relate to a method in a UE for handling transmission of an uplink data packet to a PDN. The UE determines if there is any uplink packet filter assigned to at least one bearer that matches the uplink data packet. When there is no uplink packet filter that matches the uplink data packet, the UE determines if there is any uplink packet filter on the default bearer. When there is no uplink packet filter that matches the uplink data packet and when there is no uplink packet filter on the default bearer, the UE determines that the uplink packet should be transmitted to the PDN using a default bearer. The default bearer has not been assigned any uplink packet filter.

### TECHNICAL FIELD

Embodiments herein relate generally to a User Equipment (UE) and a method in the UE. More particularly the embodiments herein relate to handling transmission of an uplink data packet to a Packet Data Network (PDN).

### BACKGROUND

When a UE requests to access a service, UE needs to establish connectivity to the PDN that provides the requested service. Such connectivity to the PDN is called a PDN connection. The service may for example be a voice call or data.

In 2nd Generation (2G) (e.g. Global System for Mobile Communications (GSM)) or 3rd Generation (3G) (e.g. Universal Mobile Telecommunications System (UMTS)), of the mobile telecommunications technology, the UE establishes a Packet Data Protocol (PDP) Context in order to establish connectivity to the PDN. The PDP Context provides an Internet Protocol (IP) address to the UE.

In Long Term Evolution (LTE), the UE creates, in the Evolved Packet System (EPS), a default EPS bearer to the PDN in order to establish connectivity to the PDN. The default EPS bearer provides an IP address to the UE, a non-guaranteed bit rate and a Quality of Service (QoS). For access to services that need a different QoS treatment, the network will create an additional bearer referred to as a dedicated EPS bearer. The UE may request the network to offer specific QoS treatment causing the network to create a dedicated bearer as needed.

The present 3rd Generation Partnership Project (3GPP) specifications for traffic mapping to bearers rely on the UE and network establishing Traffic Flow Templates (TFT) for bearers. A bearer may be referred to as a PDP Context for 2G and 3G, and may be referred to as an EPS bearer for LTE. One bearer is allowed to lack from a TFT. In fact, the initial set-up of a connection from a UE establishes a default bearer that initially never has a TFT.

The TFT comprises one or more packet filters indicating what traffic (e.g. data packets) is to be directed to the associated bearer. A TFT packet filter can be specified to be applicable for either the downlink (DL) direction or the uplink (UL) direction or be applicable for both directions. The downlink direction is from the base station to a UE, and the uplink direction is from the UE to the base station. The TFT packet filter may also be referred to as a packet filter, a data packet filter or a TFT data packet filter.

Before the 3GPP specification introduced the direction attribute for packet filters (i.e. downlink and uplink), the 3GPP specification prescribed the packet filter to be used for traffic mapping in the downlink direction only. For backward compatibility reasons, when introducing the direction attribute, the 3GPP has specified that the network shall treat such packet filters as being for both directions.

At least one Internet Protocol-Connectivity Access Network (IP-CAN) session is designated to the default bearer and the associated dedicated bearers that offer connectivity to the PDN. In LTE specifications, the PDN connection is an IP-CAN session.

When sending a data packet, the sending entity searches the packet filter(s) for the bearers in the same IP-CAN session in their order of precedence, and sends the data packet on the bearer associated with the first filter matching the data packet to send.

The sending entity also has a rule for bearer selection in case there is no matching packet filter. For the downlink direction and in case there is no matching packet filter, the network sends the data packet on the bearer without any TFT, and discards the packet if all bearers have a TFT. Early versions of the 3GPP specifications prescribed, for the uplink direction, that the packet filter should be sent on a bearer with a suitable QoS. This has later been refined at the introduction of network controlled procedures to be the bearer without a packet filter for the uplink direction, however not assuring that there never would be more than one bearer without any packet filter for the uplink direction. Due to the ambiguity that would be caused by more than one bearer having no packet filter for the uplink direction, the 3GPP specification has been recently amended to ensure that there can be only one bearer having no packet filter for the uplink direction. 3GPP has solved that by mandating that all dedicated bearers have at least one packet filter for the uplink direction.

The dilemma for the UE has been that the 3GPP specification has had nothing to prevent a situation where either (a) there is a TFT with downlink packet filters only and a bearer without a TFT or (b) there is more than one TFT with downlink packet filters only. In both of these situations there is more than one bearer without any uplink packet filter, causing the rule for traffic mapping to be ambiguous.

In 3GPP, this fact has been identified and measures have been taken to ensure that:
1) All dedicated bearers have a TFT, so that the only bearer that may lack from a TFT is the default bearer, i.e. any dedicated bearer has a TFT.
2) A TFT on a dedicated bearer has at least one uplink packet filter.
3) In case a TFT on a dedicated bearer is not intended for uplink data traffic, the network inserts a packet filter that does not match any useful traffic in that TFT. Various, complicated, phrasings have been used to refer to this kind of filter. One popular is “ . . . that effectively disallows any useful traffic”.

For the item 3, there are situations where it is either (i) not possible at all for the network to insert the packet filter, e.g. when the UE does not accept network-initiated procedures, or (ii) it would take an extra round of signalling to rectify the situation.

An example of the case (ii) is that the UE requests the deletion of 2 or more packet filters from a TFT and the TFT would, after that, have no uplink filter. Even in LTE, where the chances are better for the network to take action, the network protocol does not support two types of TFT operations within the same round of signalling. To complete the operation, there must be at least one operation that deletes packet filter(s) from the TFT, which by definition must be separate from the insertion of a dummy filter. The insertion of the dummy filter would be possible by modifying filter(s) instead of deleting them, but at deletion of two or more packet filters there would be more than one dummy filter in the same TFT.

Thus, the logic and procedures to maintain a valid state for the TFT with the rule that there may never be more than one bearer without any uplink filter is neither straightforward nor possible to maintain without extra procedures.

### SUMMARY

An objective of embodiments herein is therefore to obviate at least one of the above disadvantages and to provide improved uplink traffic mapping.

According to a first aspect, the object is achieved by a method in a UE for handling transmission of an uplink data packet to PDN. The UE is configured to communicate with the PDN, via a gateway node, using bearers between the UE and the gateway. The UE determines if there is any uplink packet filter assigned to at least one bearer that matches the uplink data packet to be transmitted to the PDN. When there is no uplink packet filter that matches the uplink data packet, the UE determines if there is any uplink packet filter on the default bearer. When there is no uplink packet filter that matches the uplink data packet and when there is no uplink packet filter on the default bearer, the UE determines that the uplink data packet should be transmitted to the PDN using a default bearer. The default bearer has not been assigned any uplink packet filter.

According to a second aspect, the object is achieved by a UE for handling transmission of an uplink data packet to a PDN. The UE is configured to communicate with the PDN, via a gateway node, using bearers between the UE and the gateway node. The UE is configured to determine if there is any uplink packet filter assigned to at least one bearer that matches the uplink data packet to be transmitted to the PDN. The UE is configured to, when there is no uplink packet filter that matches the uplink data packet, determine if there is any uplink packet filter on the default bearer. The UE is configured to, when there is no uplink packet filter that matches the uplink data packet and when there is no uplink packet filter on the default bearer, determine that the uplink data packet should be transmitted to the PDN using a default bearer. The default bearer has not been assigned any uplink packet filter.

Since the uplink data packet that matches none of the uplink packet filters is always transmitted using the default bearer which has not been assigned any uplink packet filter, the UL traffic mapping is improved. Furthermore the need for the dummy filter is eliminated with this UE behaviour since the default bearer is the only possible choice when there is no matching packet filter for the uplink direction.

Embodiments herein afford many advantages, of which a non-exhaustive list of examples follows:

An advantage of the embodiments herein is that there is no need to limit the number of bearers that has no packet filter for the uplink direction since the uplink data packet is transmitted using the default bearer. The only possible UE choice for the uplink default traffic mapping is the default bearer anyway. Thus, the extra filter (“that effectively disallows any useful traffic” and also referred to as a dummy filter) in the current 3GPP specification is not needed.

With the embodiments herein, it is not necessary for the UE to find out whether any of the dedicated bearers has no packet filter for the uplink direction because all dedicated bearers are mandated to have at least one packet filter for the uplink direction.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic block diagram illustrating embodiments of a communication system.

FIG. 2 is a flow chart illustrating embodiments of a method.

FIG. 3 is a flow chart illustrating embodiments of a method.

FIG. 4 is a flow chart illustrating embodiments of a method.

FIG. 5 is a schematic block diagram illustrating embodiments of a UE.

The drawings are not necessarily to scale and the dimensions of certain features may have been exaggerated for the sake of clarity. Emphasis is instead placed upon illustrating the principle of the embodiments herein.

### DETAILED DESCRIPTION

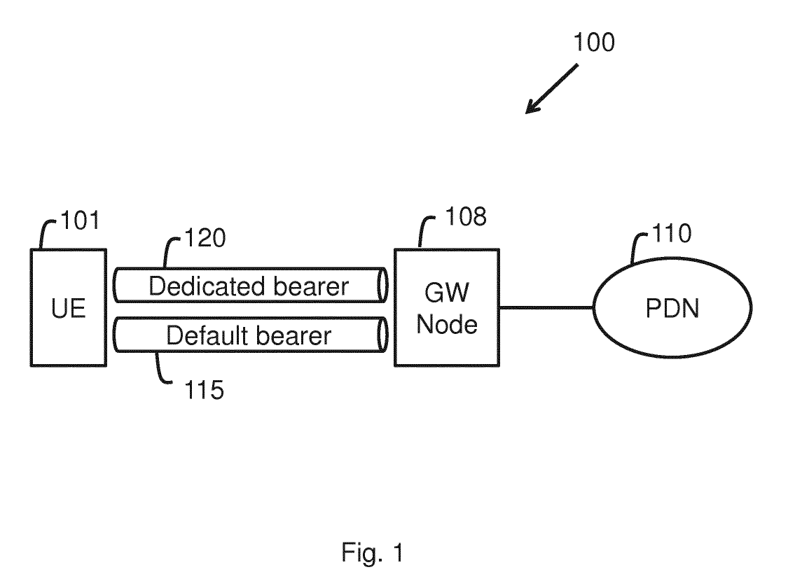

FIG. 1 depicts a communications system 100 in which embodiments herein may be implemented. The communications system 100 may in some embodiments apply to one or more radio access technologies such as for example LTE, LTE Advanced, Wideband Code Division Multiple Access (WCDMA), UMTS, GSM, or any other 3GPP radio access technology, or other radio access technologies such as a Wireless Local Area Network (WLAN).

The communications system 100 comprises a UE 101 which is served by and communicates with a Radio Access Network (RAN) comprising a RAN node (not shown in FIG. 1).

The UE 101 may be a wireless device by which a subscriber may access services offered by an operator's network and services outside the operator's network to which the operator's RAN and Core Network (CN) provide access, e.g. access to the Internet. The UE 101 may be any device, mobile or stationary, enabled to communicate in the communications network, for instance but not limited to e.g. Mobiles Station (MS), mobile phone, smart phone, sensors, meters, vehicles, household appliances, medical appliances, media players, cameras, Machine to Machine (M2M) device, Device to Device (D2D) device, Internet of Things (IoT) device or any type of consumer electronic, for instance but not limited to television, radio, lighting arrangements, tablet computer, laptop or Personal Computer (PC). The UE 101 may be portable, pocket storable, hand held, computer comprised, or vehicle mounted devices, enabled to communicate voice and/or data, via the RAN, with another entity, such as another device or a server.

The RAN resides between the UE 101 and a CN. The CN comprises network nodes such as e.g. a gateway node 108. The gateway node 108 may be e.g. a Serving GateWay (SGW), a PDN GateWay (PDN GW, PGW), a Serving General packet radio service Support Node (SGSN) etc. The gateway node 108 is configured to act as a gateway between the core network and a PDN 110 such as e.g. Internet, corporate internets, private data networks etc.

Bearers are established between the UE 101 and the gateway node 108 in order for the UE 101 to access a service provided by the PDN 110. In some embodiments, such bearers may be for example one default bearer 115. In other embodiments, such bearers may be one default bearer 115 and zero or more dedicated bearers 120. If the communication system 100 is a 2G or 3G system, the default bearer 115 may be referred to as a “PDP context that was established with a PDP Context Activation procedure” and the dedicated bearer 120 may be referred to as a “PDP context that was established with a Secondary PDP Context Activation procedure”. If the communication system 100 is an LTE system, the default bearer 115 may be referred to as a “default EPS bearer” and the dedicated bearer 120 may be referred to as a “dedicated EPS bearer”. In case of mobility of the UE 101 between 2G/3G and LTE, each bearer retains its role as default or dedicated bearer respectively. In the following, the terms default bearer 115 and dedicated bearer 120 are used regardless whether the communications system 100 is a 2G, 3G or LTE system. Some examples of the bearers are illustrated in Table 1 below:

TABLE 1

| | Default bearer 115 | Dedicated bearer 120 |
|---|---|---|
| 2G or 3G | PDP context that | PDP context that was established |
| | was established with | with a Secondary PDP Context |
| | a PDP Context | Activation procedure |
| | Activation procedure | |
| LTE | Default EPS bearer | Dedicated EPS bearer |

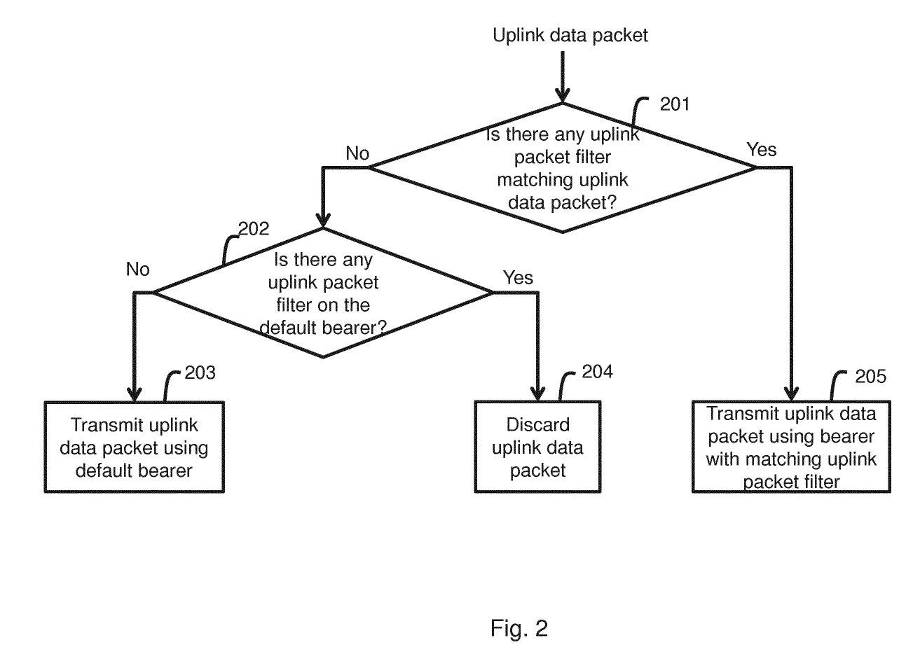

The method for handling transmission of an uplink data packet to a PDN 110 according to some embodiments will now be described with reference to the flowchart depicted in FIG. 2. As described earlier, the UE 101 is configured to communicate with a gateway node 108 using bearers 115, 120. The bearers 115, 120 are located between the UE 101 and the gateway node 108. There may be one or more bearers, for example one default bearer 115 and zero dedicated bearers 120, one default bearer 115 and one dedicated bearer 120 or one default bearer 115 and a plurality of dedicated bearers 120. A TFT comprising at least one of an uplink packet filter and a downlink packet filter is assigned to the dedicated bearer 120. In some embodiments, a TFT comprising an uplink packet filter is assigned to the dedicated bearer 120. In other embodiments, a TFT comprising a downlink packet filter is assigned to the dedicated bearer 120. In yet further embodiments, a TFT comprising an uplink packet filter and at least one downlink packet filter is assigned to the dedicated bearer 120. As mentioned earlier, the default bearer 115 does not have a TFT initially, but may later be assigned a TFT. The method in FIG. 2 comprises the following steps, which steps may as well be carried out in another suitable order than described below:

Step 201

The UE 101 has an uplink data packet to be transmitted to the PDN 110. The uplink data packet may also be referred to as uplink traffic and uplink refers to the direction for transmission of the data packet, i.e. from the UE 101 up to the PDN 110. In order to transmit the data packet, the UE 101 determines if there is any uplink packet filter matching the uplink data packet. The UE 101 checks the uplink packet filters one by one, by order. The UE 101 determines if there is any uplink packet filter (either assigned to the default bearer or the dedicated bearer) by comparing parameters in the uplink data packet and in the uplink packet filter. If all of the parameters in the packet filter are matching corresponding attributes in the data packet, then the data packet matches the packet filter. In some embodiments, the packet filter parameter employs a mask to restrict the range for comparison or a range in for the data packet attribute to match. Examples of such parameters are Remote Address and Subnet Mask, Protocol Number (e.g. Internet Protocol version 4 (IPv4))/Next Header (Internet Protocol version 6 (IPv6)), Local Address and Mask, Local Port Range, Remote Port Range, Internet Protocol Security (IPSec) Parameter Index (SPI), Type of Service (TOS) (IPv4)/Traffic class (IPv6) and Mask, Flow Label (IPv6).

If there is any uplink packet filter matching the uplink data packet, the method proceeds to step 205, indicated with “yes” in FIG. 2. If there is not any uplink packet filter matching the uplink data packet, the method proceeds to step 202, indicated with “no” in FIG. 2.

The term mapping may be used interchangeably with the term matching.

Step 202

This step is performed when the UE 101 determined in step 201 that there is not any uplink packet filters matching the uplink data packet. In step 202, the UE 101 determines if there is any uplink packet filter on the default bearer 115. If there is an uplink packet filter on the default bearer 115, the method proceeds to step 204, indicated with “yes” in FIG. 2. If there is not any uplink packet filter on the default bearer 115, the method proceeds to step 203, indicated with “no” in FIG. 2.

Step 203

This step 203 is performed when there is no uplink packet filter matching the uplink data packet and when there is no uplink packet filter on the default bearer 115. In such case, the UE 101 transmits the uplink data packet using the default bearer 115.

Step 204

This step is performed when there is no uplink packet filter matching the uplink data packet and when there is an uplink packet filter on the default bearer. In such case, the UE 101 discards the uplink data packet.

Step 205

This step is performed when there is an uplink packet filter matching the uplink data packet. In such case, the uplink data packet is transmitted using the bearer with the matching uplink packet filter.

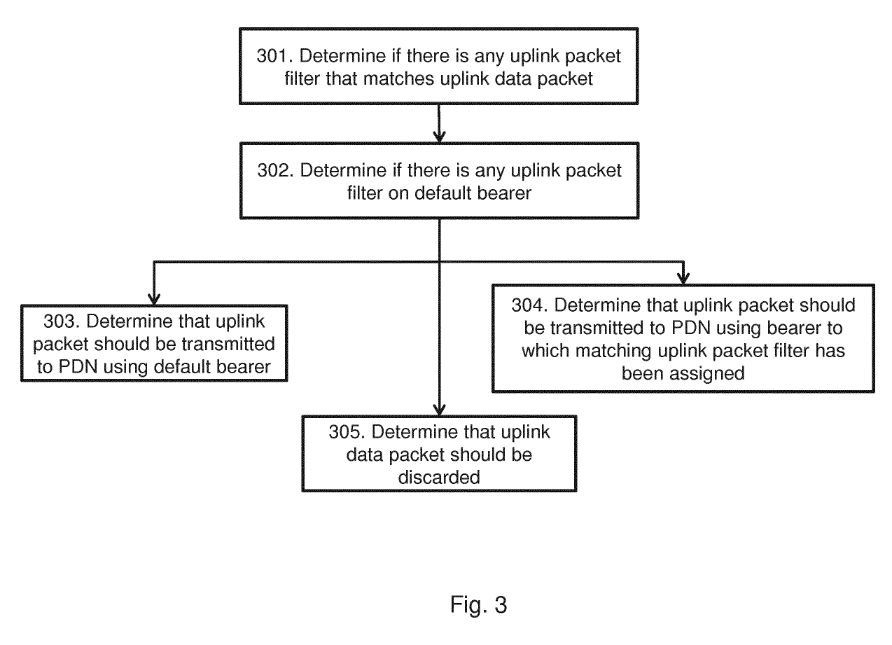

The method described above will now be described seen from the perspective of the UE 101. FIG. 3 is a flowchart describing the present method in the UE 101 for handling transmission of an uplink data packet to a PDN 110. The UE 101 is configured to communicate with the PDN 110, via a gateway node 108, using bearers 115, 120 between the UE 101 and the gateway node 108. The bearers 115, 120 may comprise a default bearer 115 and zero or more dedicated bearers 120. A TFT may comprise packet filters assigned to the dedicated bearers 120. The packet filters may be at least one of an uplink packet filter and a downlink packet filter. The method comprises the following steps to be performed by the UE 101, which steps may be performed in any suitable order than described below:

Step 301

This step corresponds to step 201 in FIG. 2. The UE 101 determines if there is any uplink packet filter assigned to at least one bearer 115, 120 that matches the uplink data packet to be transmitted to the PDN 110.

In some embodiments, the TFT assigned to at least one of the dedicated bearers 120 comprises uplink packet filters that do not match the uplink data packet.

In some embodiments, the TFT assigned to the dedicated bearer 120 comprises downlink packet filters and no uplink packet filters.

In some embodiments, the dedicated bearer 120 is not required to comprise at least one uplink packet filter.

Step 302

This step corresponds to step 202 in FIG. 2. When there is no uplink packet filter that matches the uplink data packet, the UE 101 determines if there is any uplink packet filter on the default bearer 115.

Step 303

This step corresponds to step 203 in FIG. 2. When there is no uplink packet filter that matches the uplink data packet and when there is no uplink packet filter on the default bearer, the UE 101 determines that the uplink data packet should be transmitted to the PDN 110 using a default bearer 115. The default bearer 115 has not been assigned any uplink packet filter. After the UE 101 has made the decision in step 303, the UE 101 transmits the uplink packet using the default bearer 115 as determined.

In some embodiments, the uplink data packet is transmitted using the default bearer 115 even though there is more than one bearer that has not been assigned any uplink packet filter.

Step 304

This step corresponds to step 205 in FIG. 2. In some embodiments, when there is an uplink packet filter that matches the uplink data packet, the UE 101 determines that the uplink data packet should be transmitted to the PDN 110 using the bearer to which the matching uplink packet filter has been assigned. Such bearer may be a dedicated bearer 120.

After the UE 101 has made the decision in step 304, the UE 101 transmits the uplink data packet using the bearer to which has a matching uplink packet filter, as determined.

Step 305

This step corresponds to step 204 in FIG. 2. In some embodiments, when there is no uplink packet filter that matches the uplink data packet and when there is an uplink packet filter on the default bearer 115, the UE 101 determines that the uplink data packet should be discarded. It is only the default bearer that is allowed to take uplink traffic without having any uplink packet filter.

After the UE 101 has made the decision in step 305, the UE 101 discards the uplink data packet.

The only bearer which may take uplink traffic without having an uplink packet filter is the default bearer. By specification all dedicated bearers have at least one uplink packet filter. Thus, the default bearer is the only bearer which does not have an uplink packet filter. As a result of this, the need for processor power to decide which bearer the uplink data packet should be transmitted on is reduced since there is no need for inspecting any dedicated bearer. Furthermore, it introduces a tolerance for that the rule by specification that requires at least one uplink packet filter on every dedicated bearer is not completely fulfilled.

In an example of 2G and 3G, if no match of uplink packet filter and uplink data packet is found, the UE 101 shall send the PDP Packet Data Unit (PDU) via the PDP context that has not been assigned any uplink packet filter, i.e. the default bearer. In an example of LTE, if no match is found, the uplink data packet shall be sent via the EPS bearer that has not been assigned any uplink packet filter, i.e. the default bearer. Both the 2G/3G and the LTE examples imply that there is at most one EPS bearer without any uplink packet filter, and this is the default bearer. To ensure that at most one EPS bearer exists without any uplink packet filter, a Policy and Charging Enforcement Function (PCEF) (for General packet radio services Tunneling Protocol (GTP)-based S5/S8) or a Bearer Binding and Event Reporting Function (BBERF) (for Proxy Mobile IPv6 (PMIP)-based S5/S8) maintains a valid state for the TFT settings of the PDN connection. The UE behavior according to the embodiments herein removes the need for the rule for uplink packet filter setting.

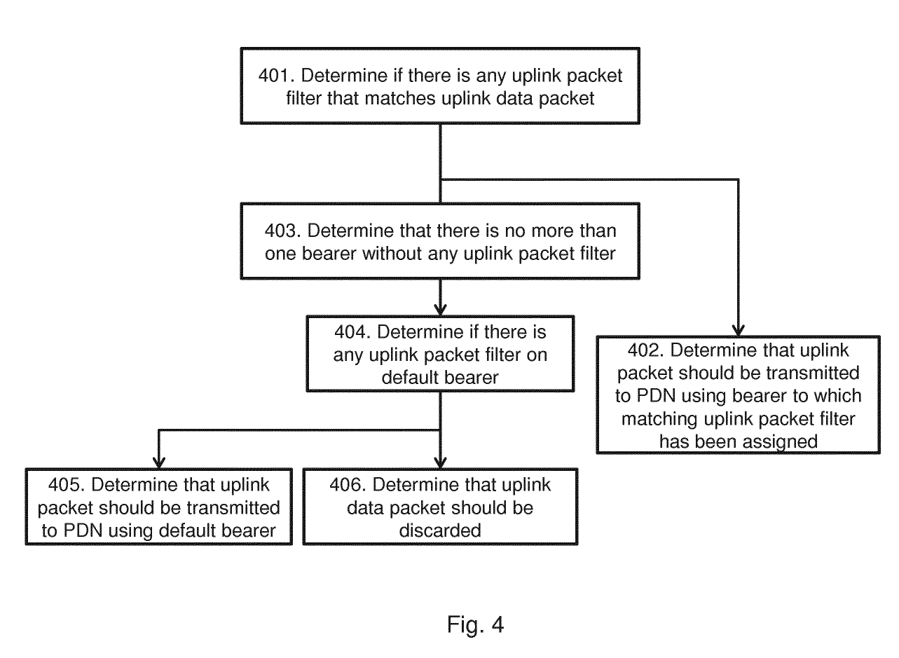

FIG. 4 is a flowchart describing the present method in the UE 101 for handling transmission of an uplink data packet to a PDN 110. FIG. 4 is an alternative way of illustrating the method in FIG. 3. The method in FIG. 4 comprises at least some of the following steps to be performed by the UE 101, which steps may be performed in any suitable order than described below:

Step 401

This step corresponds to step 201 in FIG. 2 and step 301 in FIG. 3. The UE 101 determines if there is any uplink packet filter assigned to at least one bearer 115, 120 that matches the uplink data packet to be transmitted to the PDN 110.

In some embodiments, the TFT assigned to at least one of the dedicated bearers 120 comprises uplink packet filters that do not match the uplink data packet.

In some embodiments, the TFT assigned to the dedicated bearer 120 comprises downlink packet filters and no uplink packet filters.

In some embodiments, the dedicated bearer 120 is not required to comprise at least one uplink packet filter.

Step 402

This step corresponds to step 205 in FIG. 2 and step 304 in FIG. 3. In some embodiments, when there is an uplink packet filter that matches the uplink data packet, the UE 101 determines that the uplink data packet should be transmitted to the PDN 110 using the bearer to which the matching uplink packet filter has been assigned. Such bearer may be a dedicated bearer 120.

After the UE 101 has made the decision in step 304, the UE 101 transmits the uplink data packet using the bearer to which has a matching uplink packet filter, as determined.

Step 403

The UE 101 may determine that there is no more than one bearer 115, 120 without any uplink packet filter. This is an optional step which may not be necessary to be perform.

Step 404

This step corresponds to step 202 in FIG. 2 and step 302 in FIG. 3. When there is no uplink packet filter that matches the uplink data packet, the UE 101 determines if there is any uplink packet filter on the default bearer 115.

Step 405

This step corresponds to step 203 in FIG. 2 and step 303 in FIG. 3. When there is no uplink packet filter that matches the uplink data packet and when there is no uplink packet filter on the default bearer, the UE 101 determines that the uplink data packet should be transmitted to the PDN 110 using a default bearer 115. The default bearer 115 has not been assigned any uplink packet filter. After the UE 101 has made the decision in step 303, the UE 101 transmits the uplink packet using the default bearer 115 as determined.

In some embodiments, the uplink data packet is transmitted using the default bearer 115 even though there is more than one bearer that has not been assigned any uplink packet filter.

Step 406

This step corresponds to step 204 in FIG. 2 and step 305 in FIG. 3. In some embodiments, when there is no uplink packet filter that matches the uplink data packet and when there is an uplink packet filter on the default bearer 115, the UE 101 determines that the uplink data packet should be discarded. It is only the default bearer that is allowed to take uplink traffic be without having any uplink packet filter.

After the UE 101 has made the decision in step 406, the UE 101 discards the uplink data packet.

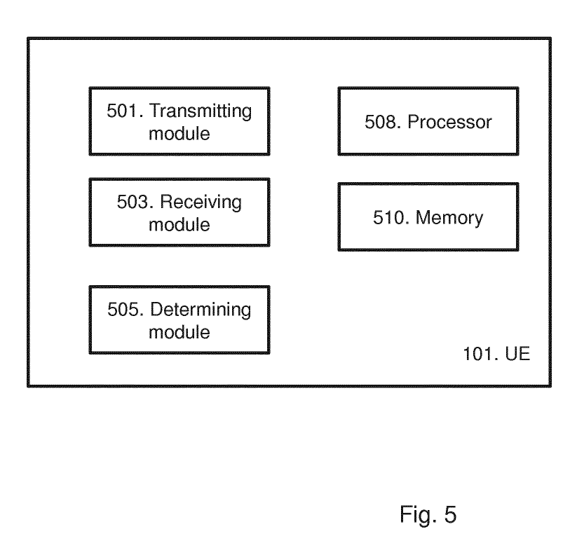

To perform the method steps shown in FIG. 3 and FIG. 4 for handling transmission of an uplink data packet to the PDN 110, the UE 101 may comprise an arrangement as shown in FIG. 5.

The UE 101 is configured to, e.g. by means of a transmitting module 501 and a receiving module 503, communicate with the PDN 110 via a gateway node 108 using bearers 115, 120 between the UE 101 and the gateway node 108. The bearers 115, 120 may comprise a default bearer 115 and zero or more dedicated bearers 120. A TFT may comprise at least one packet filter assigned to the dedicated bearers 120. The at least one packet filter may be an uplink packet filter or a downlink packet filter or both an uplink packet filter and a downlink packet filter. The transmitting module 501 may also be referred to as a transmitting unit, a transmitting means, a transmitting circuit, means for transmitting or an output unit. The transmitting module 501 may be a transmitter, a transceiver etc. The transmitting module 501 may be a wireless transmitter of the UE 101 of a wireless or fixed communications system. The receiving module 503 may also be referred to as a receiving unit, a receiving means, a receiving circuit, means for receiving or an input unit. The receiving module 503 may be a receiving, a transceiver etc. The receiving module 503 may be a wireless receiver of the UE 101 of a wireless or fixed communications system.

The UE 101 is configured to, e.g. by means of a determining module 505, determine if there is any uplink packet filter assigned to at least one bearer 115, 120 that matches the uplink data packet to be transmitted to the PDN 110. The determining module 505 may also be referred to as a determining unit, a determining means, a determining circuit or means for determining. The determining module 505 may be a processor 508 of the UE 101. In some embodiments, the TFT assigned to at least one of the dedicated bearers 120 comprises uplink packet filters that do not match the uplink data packet. In some embodiments, the TFT assigned to the dedicated bearer 120 comprises downlink packet filters and no uplink packet filters. In some embodiments, the dedicated bearer is not required to comprise at least one uplink packet filter.

The UE 101 is configured to, e.g. by means of the determining module 505, when there is no uplink packet filter that matches the uplink data packet, determine if there is any uplink packet filter on the default bearer 115.

The UE 101 is further configured to, e.g. by means of the determining module 505, when there is no uplink packet filter that matches the uplink data packet and when there is no uplink packet filter on the default bearer 115, determine that the uplink data packet should be transmitted to the PDN 110 using the default bearer 115. The default bearer 115 has not been assigned any uplink packet filter. In some embodiments, the uplink data packet is transmitted using the default bearer 115 even though there is more than one bearer that has not been assigned any uplink packet filter.

In some embodiments, the UE 101 is further configured to, e.g. by means of the determining module 505, when there is an uplink packet filter that matches the uplink data packet, determine that the uplink data packet should be transmitted to the PDN 110 using the bearer 115, 120 to which the matching uplink packet filter has been assigned.

In some embodiments, the UE 101 is configured to, e.g. by means of the determining module 505, when there is no uplink packet filter that matches the uplink data packet and when there is an uplink packet filter on the default bearer 115, determine that the uplink data packet should be discarded.

In some embodiments, the UE 101 comprises the processor 508 and a memory 510. The memory 510 comprises instructions executable by the processor 508. The memory 510 comprises one or more memory units. The memory 510 is arranged to be used to store data, received data streams, power level measurements, uplink data packets, TFTs, uplink packet filters, downlink packet filters, threshold values, time periods, configurations, schedulings, and applications to perform the methods herein when being executed in the UE 101.

Those skilled in the art will also appreciate that the transmitting module 501, the receiving module 503 and the determining module 505 described above may refer to a combination of analog and digital circuits, and/or one or more processors configured with software and/or firmware, e.g. stored in a memory, that when executed by the one or more processors such as the processor 508 perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The present mechanism for handling transmission of an uplink data packet to PDN 110 may be implemented through one or more processors, such as the processor 508 in the UE arrangement depicted in FIG. 5, together with computer program code for performing the functions of the embodiments herein. The processor may be for example a Digital Signal Processor (DSP), ASIC processor, Field-programmable gate array (FPGA) processor or microprocessor. The program code mentioned above may also be provided as a computer program product, for instance in the form of a data carrier carrying computer program code for performing the embodiments herein when being loaded into the UE 101. One such carrier may be in the form of a CD ROM disc. It is however feasible with other data carriers such as a memory stick. The computer program code can furthermore be provided as pure program code on a server and downloaded to the UE 101.

A computer program may comprise instructions which, when executed on at least one processor, cause the at least one processor to carry out the method as described in FIGS. 2, 3 and 4. A carrier may comprise the computer program, and the carrier may be one of an electronic signal, optical signal, radio signal or computer readable storage medium.

Summarized, since the 3GPP specification ensures that the only candidate bearer that the UE 101 may use for uplink data traffic that does not match any TFT packet filter, is the default bearer, then it suffice that the UE 101 considers the TFT setting for the default bearer alone. If the default bearer has no uplink packet filter (either (A) the bearer has no

TFT or (B) has a TFT with downlink packet filters only), then the UE 101 sends the uplink data packet on that bearer. Otherwise (as per legacy specification), the UE 101 discards the uplink data packet.

The extra filter (e.g. the dummy filter) for the purpose of complying with the rules for the TFT filter setting is proven both non-effective and unnecessary based on the present 3GPP Release 11 specifications. The embodiments herein remove the use of the extra filter for substantially all purposes except the case of a dedicated bearer that otherwise would have no TFT at all.

With the embodiments herein, the UE traffic mapping to bearers for uplink data packets that do not match any packet filter is simplified to consider the default bearer only. The extra filter, e.g. dummy filter, (as per present 3GPP specification needed) that the network introduces is not needed and complicated logic is deprecated with the embodiments herein. The embodiments herein remove any UE 101 requirement to obey any specific rule for the TFT packet filter settings.

For the uplink direction and in case there is no matching packet filter, the UE 101 is expected to send the data packet on the default bearer, if that bearer has no uplink packet filter.

The embodiments herein are not limited to the above described embodiments. Various alternatives, modifications and equivalents may be used. Therefore, the above embodiments should not be taken as limiting the scope of the embodiments, which is defined by the appending claims.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasised that the steps of the methods defined in the appended claims may, without departing from the embodiments herein, be performed in another order than the order in which they appear in the claims.

1. A method in a User Equipment, UE for handling transmission of an uplink data packet to a Packet Data Network, PDN, wherein the UE is configured to communicate with the PDN via a gateway node using bearers between the UE and the gateway node, the method comprising:
determining if there is any uplink packet filter assigned to at least one bearer that matches the uplink data packet to be transmitted to the PDN;
when there is no uplink packet filter that matches the uplink data packet, determining if there is any uplink packet filter on a default bearer; and
when there is no uplink packet filter that matches the uplink data packet and when there is no uplink packet filter on the default bearer, determining that the uplink data packet should be transmitted to the PDN using the default bearer, wherein the default bearer has not been assigned any uplink packet filter.

2. The method according to claim 1, further comprising:
when there is an uplink packet filter that matches the uplink data packet, determining that the uplink data packet should be transmitted to the PDN using the bearer to which the matching uplink packet filter has been assigned.

3. The method according to claim 1, further comprising:
when there is no uplink packet filter that matches the uplink data packet and when there is an uplink packet filter on the default bearer, determining that the uplink data packet should be discarded.

4. The method according to claim 1, wherein a Traffic Flow Template, TFT, comprises at least one packet filter assigned to a dedicated bearer, and wherein the at least one packet filter is an uplink packet filter.

5. The method according to claim 1, wherein the bearers comprise the default bearer and zero or more dedicated bearers, and wherein a Traffic Flow Template, TFT, comprises packet filters assigned to the dedicated bearers.

6. The method according to claim 5, wherein the TFT assigned to at least one of the dedicated bearers comprises uplink packet filters that do not match the uplink data packet.

7. The method according to claim 5, wherein the TFT assigned to the dedicated bearer comprises downlink packet filters and no uplink packet filters.

8. The method according to claim 5, wherein the dedicated bearer is not required to comprise at least one uplink packet filter.

9. The method according to claim 1, wherein the uplink data packet is transmitted using the default bearer even though there is more than one bearer that have not been assigned any uplink packet filter.

10. A User Equipment, UE for handling transmission of an uplink data packet to a Packet Data Network, PDN, the UE being configured to:
communicate with the PDN via a gateway node using bearers between the UE and the gateway node;
determine if there is any uplink packet filter assigned to at least one bearer that matches the uplink data packet to be transmitted to the PDN;
when there is no uplink packet filter that matches the uplink data packet, determine if there is any uplink packet filter on a default bearer; and to
when there is no uplink packet filter that matches the uplink data packet and when there is no uplink packet filter on the default bearer, determine that the uplink data packet should be transmitted to the PDN using the default bearer, wherein the default bearer has not been assigned any uplink packet filter.

11. The UE according to claim 10, being further configured to:
when there is an uplink packet filter that matches the uplink data packet, determine that the uplink data packet should be transmitted to the PDN using the bearer to which the matching uplink packet filter has been assigned.

12. The UE according to claim 10, being further configured to:
when there is no uplink packet filter that matches the uplink data packet and when there is an uplink packet filter on the default bearer, determine that the uplink data packet should be discarded.

13. The UE according to claim 10,
wherein a Traffic Flow Template, TFT, comprises at least one packet filter assigned to a dedicated bearer, and wherein the at least one packet filter is an uplink packet filter.

14. The UE according to claim 10,
wherein the bearers comprise the default bearer and zero or more dedicated bearers, and
wherein a Traffic Flow Template, TFT, comprising at least one packet filter is assigned to the dedicated bearers.

15. The UE according to claim 14, wherein the TFT assigned to at least one of the dedicated bearers comprises uplink packet filters that do not match the uplink data packet.

16. The UE according to claim 14, wherein the TFT assigned to the dedicated bearers comprises downlink packet filters and no uplink packet filters.

17. The UE according to claim 14,
wherein the dedicated bearers are not required to comprise at least one uplink packet filter.

18. The UE according to claim 10,
wherein the uplink data packet is transmitted using the default bearer even though there is more than one bearer that have not been assigned any uplink packet filter.

19. (canceled)

20. (canceled)
